(19) United States
(12) Patent Application Publication
(10) Pub. No.: US 2016/0154634 A1
(43) Pub. Date: Jun. 2, 2016

(54) MODIFYING AN ANALYTIC FLOW

(71) Applicant: HEWLETT-PACKARD DEVELOPMENT COMPANY, L.P., Houston, TX (US)

(72) Inventors: Alkiviadis Simitsis, Santa Clara, CA (US); William K. Wilkinson, San Mateo, CA (US)

(73) Assignee: Hewlett-Packard Development Company, L.P., Houston, TX (US)

(21) Appl. No.: 14/787,281

(22) PCT Filed: Jun. 26, 2013
(86) PCT No.: PCT/US2013/047765

§ 371 Date: Oct. 27, 2015

(51) Int. Cl. G06F 9/45; G06F 9/44

(52) U.S. Cl. CPC G06F 8/433; G06F 9/44; G06F 8/34

(57) ABSTRACT

Described herein are techniques for modifying an analytic flow. A flow may be associated with an execution engine. A flow graph representative of the flow may be obtained. The flow graph may be modified using a logical language. For example, a new flow graph expressed in the logical language may be generated. A program may be generated from the modified flow graph.

### BACKGROUND

There are numerous execution engines used to process analytic flows. These engines may only accept input flows expressed in a high-level programming language, such as a particular scripting language (e.g., PigLatin, Structured Query Language (SQL)) or the language of a certain flow-design tool (e.g., Pentaho Data Integration (PDI) platform). Furthermore, even execution engines supporting the same programming language or flow-design tool may provide different implementations of analytic operations and the like. Thus, an input flow for one engine may be different than an input flow for another engine, even though the flows are intended to achieve the same result. It can be challenging and time-consuming to modify analytic flows due to these considerations. Furthermore, it is similarly difficult to have a one-size-fits-all solution for modifying analytic flows in heterogeneous analytic environments, which often include various execution engines.

### BRIEF DESCRIPTION OF DRAWINGS

The following detailed description refers to the drawings, wherein:

FIG. 1 illustrates a method of modifying an analytic flow, according to an example.

FIG. 2 illustrates a method of modifying a flow graph, according to an example.

FIG. 3 illustrates an example flow, according to an example.

FIG. 4 illustrates an example execution plan corresponding to the example flow with parsing notations, according to an example.

FIG. 5 illustrates a computing system for modifying an analytic flow, according to an example.

FIG. 6 illustrates a computer-readable medium for modifying an analytic flow, according to an example.

FIG. 7 illustrates experimental results obtained using the disclosed techniques, according to an example.

### DETAILED DESCRIPTION

As described herein, this relates to analytic data processing engines that apply a sequence of operations to one or more datasets, This sequence of operations is referred to herein as a “flow” because the analytic computation can be modeled as a directed graph in which nodes represent operations on datasets and arcs represent data flow between operations. The flow is typically specified in a high-level language that is easy for people to write, read and comprehend. The high-level language representation of given flow is referred to herein as a “program”. For example, the high-level language may be a particular scripting language (e.g., PigLatin, Structured Query Language (SQL)) or the language of a certain flow-design tool (e.g., Pentaho Data Integration (PDI) platform). In some cases, the analytic engine is a black box, i.e., its internal processes are hidden. In order to modify a program intended to be input into a black box execution engine, generally an adjunct processing engine is written that is an independent software module intermediary between the execution engine and the application used to create the program. This adjunct engine can then be used to create a new, modified program from the original program, where the new program has additional features. To do this, the adjunct engine generally needs to understand the semantics of the program. Writing such an adjunct engine can be difficult because of the numerous different execution engines in heterogeneous analytic environments, the engines supporting various languages and many having unique engine-specific implementations of operations. Furthermore, a program can often be expressed in various ways to achieve the same result. Additionally, translation of the program may require meta-data that may not be visible outside the black box execution engine, thus requiring inference, which is often error-prone.

Many analytic engines support an “explain plan” command that, given a source program, returns a flow graph for that program. This flow graph can be referred to as an “execution plan” or an “explain plan” (hereafter referred to herein as “execution plan”). The disclosed systems and methods leverage the execution plan by parsing it rather than the user-specified high-level language program. This may be a simpler task and may be more informative, since some physical choices made by the analytic engine optimizer may be available in the execution plan that would not be available in the original source program (e.g., implementation algorithms, cost estimates, resource utilization). The adjunct engine may then modify the flow graph to add functionality. The adjunct engine may then generate a new program in a high-level language from the modified flow graph for execution in the black box execution engine (or some other engine). Furthermore, optimization and decomposition may be applied, such that the flow may be executed in a more efficient fashion.

According to an example, a technique implementing the principles described herein can include receiving a flow associated with a first execution engine. A flow graph representative of the flow may be obtained. For example, an execution plan may be requested from the first execution engine. The flow graph may be modified using a logical language. For example, a logical flow graph expressed in the logical language may be generated. A program may be generated from the modified flow graph for execution on an execution engine. The execution engine may be the first execution engine, or it may be a different execution engine. Furthermore, the execution engine may be more than one execution engine, such that multiple programs generated. Additional examples, advantages, features, modifications and the like are described below with reference to the drawings.

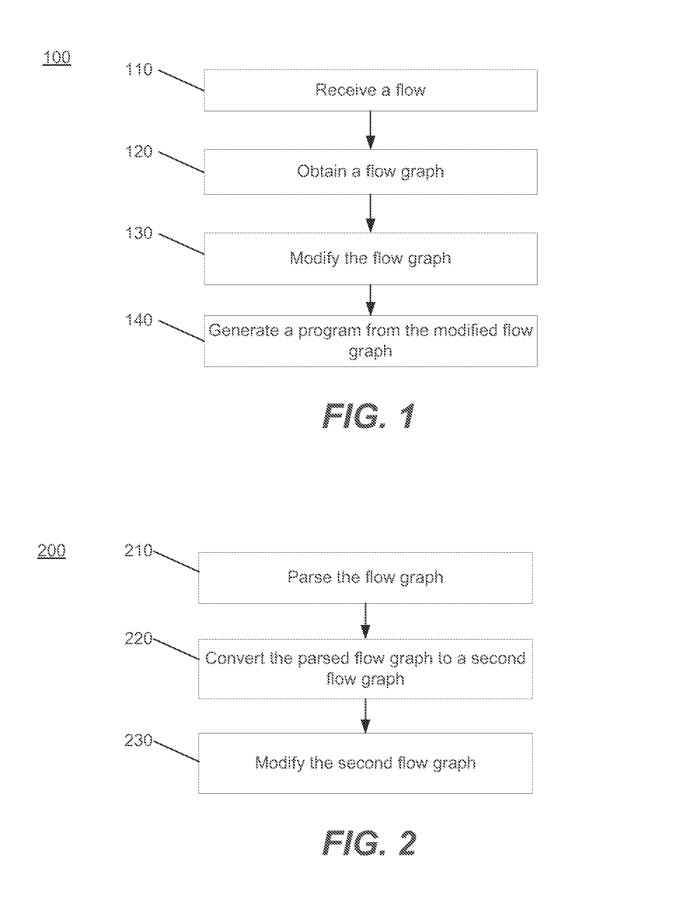

FIG. 1 illustrates a method of modifying an analytic flow, according to an example. Method 100 may be performed by a computing device, system, or computer, such as computing system 500 or computer 600. Computer-readable instructions for implementing method 100 may be stored on a computer readable storage medium. These instructions as stored on the medium are referred to herein as “modules” and may be executed by a computer.

Method 100 may begin at 110, where a flow associated with a first execution engine may be received. The flow may include implementation details such as implementation type, resources, storage paths, etc., and are specific to the first execution engine. For example, the flow may be expressed in a high-level programming language, such as a particular programming language (e.g., SQL, PigLatin) or the language of a particular flow-design tool, such as the Extract-Transform-Load (ETL) flow-design tool PDI, depending on the type of the first execution engine.

There may be more than one flow. For example, a hybrid flow may be received, which may include multiple portions (i.e., sub-flows) directed to different execution engines. For example, a first flow may be written in SQL and a second portion may be written in PigLatin. Additionally, there may be differences between execution engines that support the same programming language. For example, a script for a first SQL execution engine (e.g., HP Vertica SQL engine) may be incompatible with (e.g., may not run properly on) a second SQL execution engine (e.g., Oracle SQL engine).

At 120, a flow graph representative of the flow may be obtained. The flow graph may be an execution plan obtained from the first execution engine. For example, the explain plan command may be used to request the execution plan. If there are multiple flows, a separate execution plan may be obtained for each flow from the flow's respective execution engine. If the flow is expressed in a language of a flow-design tool, a flow specification (e.g., expressed in XML) may be requested from the associated execution engine. A flow graph may be generated based on the flow specification received from the engine.

At 130, the flow graph may be modified using a logical language. FIG. 2 illustrates a method 200 for modifying the flow graph, according to an example.

At 210, the flow graph may be parsed into multiple elements. For example, a parser can analyze the flow graph and obtain engine-specific information for each operator or data store of the flow. The parser may output nodes (referred to herein as “elements”) that make up the flow graph. Since the parser is engine specific, there may be a separate parser for each engine supported. Such parsers may be added to the system as a plugin.

At 220, the parsed flow graph may be converted to a second flow graph in a logical language. This second flow graph is referred to herein as a “logical flow graph”. The logical flow graph may be generated by converting the multiple elements into logical elements represented in the logical language. Here, the example logical language is xLM, which is a logical language developed for analytic flows by Hewlett-Packard Company's HP Labs, However, other logical languages may be used. Additionally, a dictionary may be used to perform this conversion. The dictionary can include a mapping between the logical language and a programming language associated with the at least one execution engine of the first physical flow. Thus, the dictionary 224 enables translation of the engine-specific multiple elements into engine-agnostic logical elements, which make up the logical flow. The dictionary and the associated conversion are described in further detail in PCT/U.S.2013/047252, filed on Jun. 24, 2013, which is hereby incorporated by reference.

At 230, the logical flow graph may be modified. For example, various optimizations may be performed on the logical flow graph, either in an automated fashion or through manual manipulation in the GUI. Such optimizations may not have been possible when dealing with just the flow for various reasons, such as because the flow was a hybrid flow, because the flow included user-defined functions not optimizable by the flow's execution engine, etc. Relatedly, statistics on the logical flow graph may be gathered. Additionally, the logical flow graph may be displayed graphically in a graphical user interface (GUI). This can provide a user a better understanding of the flow (compared to its original incarnation), especially if the flow was a hybrid flow.

Furthermore, the logical flow graph may be decomposed into sub-flows to take advantage of a particular execution environment. For example, the execution environment may have various heterogeneous execution engines that may be leveraged to work together to execute the flow in its entirely in a more efficient manner. A flow execution scheduler may be employed in this regard. Similarly, the logical flow graph may be combined with another logical flow graph associated with another flow. The other flow may have been directed to a different execution engine and may not have been compatible with the first execution engine. Expressed in the logical flow graph, however, the two flows may now be combinable using a connector.

Returning to FIG. 1, at 140 a program may be generated from the modified flow graph (i.e., the logical flow graph). The program may be generated for execution on an execution engine. The execution engine may be the first execution engine, or it may be a different execution engine. Additionally, it may be multiple execution engines, in the case that the logical flow graph was decomposed into sub-flows. The program(s) may thus be expressed in a high-level language appropriate for each execution engine for which it is intended.

This conversion may involve generating an intermediate version of the logical flow graph that is engine-specific, and then generating program code from that intermediate version. While the logical flow graph describes the main flow structure, many engine-specific details may not be included during the initial conversion to the logical language (e.g., xLM). These details include paths to data storage in a script or the coordinates or other design metadata in a flow design. Such details may be retrieved when producing engine-specific xLM. In addition, other xLM constructs like the operator type or the normal expression form that is being used to represent expressions for operator parameters should be converted into an engine-specific format. These conversions may be performed by an xLM parser. Additionally, some engines require some additional flow metadata (e.g., a flow-design tool may need shape, color, size, and location of the flow constructs) to process and to use a flow. The dictionary may contain templates with default metadata information for operator representation in different engines.

The program may be finally generated by generating code from the engine-specific second logical representation (engine-specific xLM). The code may be executable on the one or more execution engines. This conversion to executable code may be accomplished using code templates. The engine-specific xLM may be parsed by parsing each xLM element of engine-specific xLM, being sure to respect any dependencies each element may have, In particular, code templates may be searched for each element to find a template corresponding to the specific operation, implementation, and engine as dictated by the xLM element.

For flows that comprised multiple portions (e.g., hybrid flows), the logical flow may represent the multiple portions as connected via connector operators. For producing execution code, depending on the chosen execution engines and storage repositories, the connector operators may be instantiated to appropriate formats (e.g., a database to map-reduce connector, a script that transfers data from repository A to repository B). The program(s) may then be output and dispatched to the appropriate engines for execution.

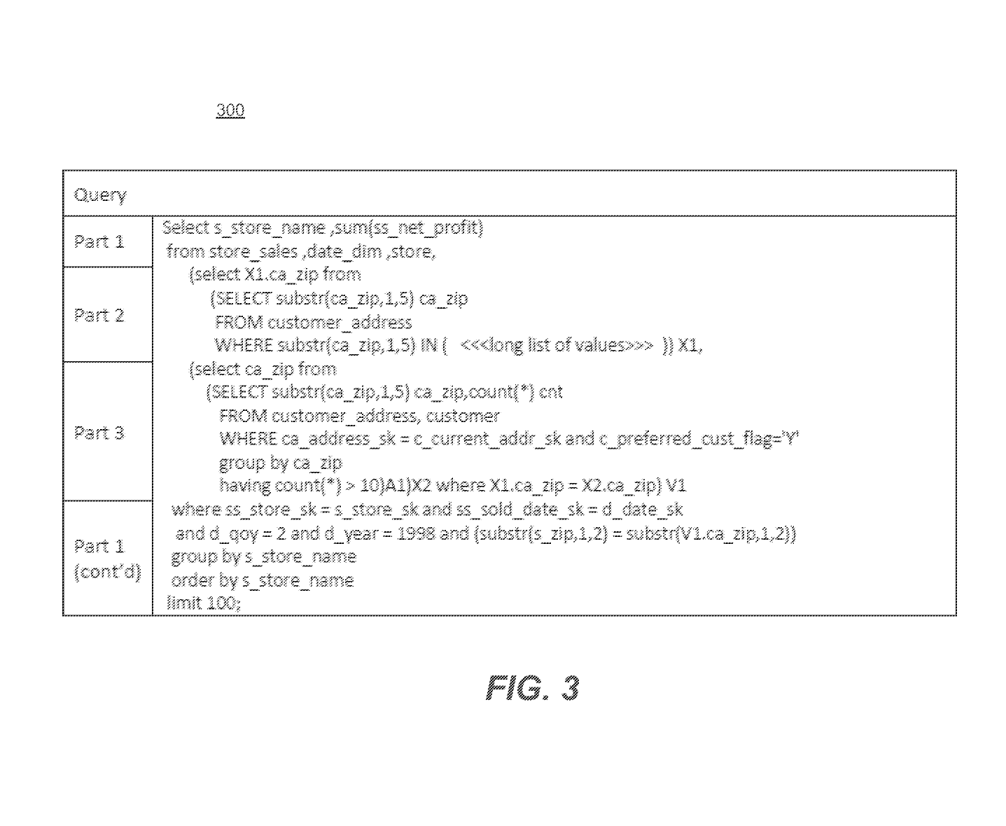

An illustrative example involving a flow and execution plan will now be described. FIG. 3 illustrates an example flow 300 expressed as an SQL query. The flow 300 is shown divided into three main logical parts. These dividing lines are candidates for adding cut points for decomposition of this single flow into multiple parts (or “sub-flows”).

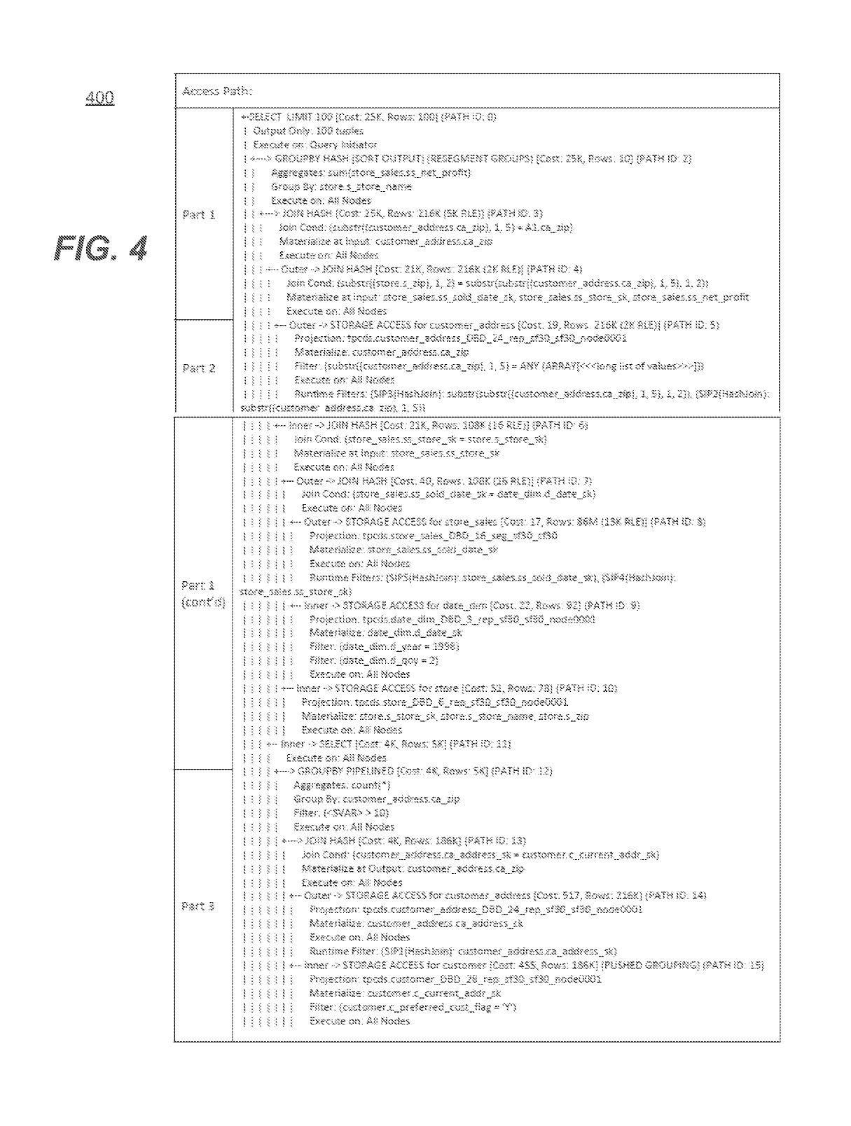

FIG. 4 illustrates an example execution plan 400 for flow 300 that may be generated by an execution engine in response to an explain plan command. The execution plan 400 is also shown divided into the same three logical parts corresponding to flow 300. The execution plan 400 may be parsed as follows. A queue Q (here, a last-in-first-out (LIFO) queue) may be maintained for adding flow operators as they are read from the execution plan 400. Parsing may begin at plan 400's root (indicated by “+−”), which is followed by an operator name (“SELECT”). SELECT is added to Q. The plan has different levels, which are indicated by the symbol “|”. Parsing may continue through the plan with every new operator being added to Q. At each level, priority goes to the first encountered operator. New operators are indicated in FIG. 4 with the symbol “|+→”. If an operator is binary, its children are denoted separately (e.g., to separate outer by inner relations in a JOIN operator). In this case, a special symbol may be used to denote this (e.g., here, “| | | | +−Inner →” denotes the inner relation at a depth of 4). When the plan has been parsed, all the elements may be dequeued from Q in reverse order. Each element is a flow operator in the flow graph.

As described previously, the adjunct processing engine may modify a flow by performing flow decomposition. Flow decomposition may be useful for enabling faster execution or reducing resource contention. Possible candidate places for splitting a flow are at different levels, when select-style operators are nested, after expensive operations, and so on. Such points may also serve as recovery points, so that the enhanced program has improved fault tolerance.

To aid in decomposition, a degree of nesting λ for a flow may be determined based on execution requirements and service level objectives, which may be expressed as an objective function. An example objective function that aims at reducing resource contention may take as arguments a given flow, a threshold for a flow's acceptable execution window, the associated execution engine(s) for running the flow, and the system status (e.g., system utilization, pending workload).

The degree of nesting λ may be a concrete value (e.g., a number or percentage) or a more abstract value (e.g., in the range [‘low—unnested’, ‘medium’, ‘high—nested’]). Using λ, it can be estimated how many flow fragments k to produce (i.e., how many sub-flows the input flow should be decomposed into). An example estimate may be computed as a function of the ratio of the flow size over λ (e.g., #nodes/λ). For large values of λ (high nesting), the number of flow fragments k is low, and as λ→∞, k→0. In contrast, for smaller values of λ, the flow can be decomposed more aggressively. Thus, the other extreme is as λ→0, k→∞, which essentially means that the flow should be decomposed after every operator (each operator comprises a single flow fragment/sub-flow).

As an example, if the flow is implemented in SQL, then it can be seen as a query (or queries). In this case, as λ→∞, the query is as nested as possible. For instance, for a flow consisting of two SQL statements that create a table and a view (e.g., the view reads data from the table), the flow cannot contain less than two flow fragments. But for flow 300, the nested version is as shown in FIG. 4. On the other hand, as λ→0, then the query is decomposed to as many fragments as the number of its operators, and the fragments are connected to each other through intermediate tables. For instance, flow 300 could be decomposed into a maximum of three fragments, each corresponding to one of the three main logical parts,

Subsequently, when the degree of nesting is available, the execution plan may be parsed using λ. For example, a parse function performing the parsing may take as an optional argument the degree of nesting. Then, at every new operator, a cost function may be evaluated to check whether it makes sense to add a cut point at that spot. Based on the λ value, a cut point may be added to the flow after the operator currently being parsed. Thus, the λ value may be considered to be a knob that determines if the cost function should be more or less conservative (or equally, aggressive).

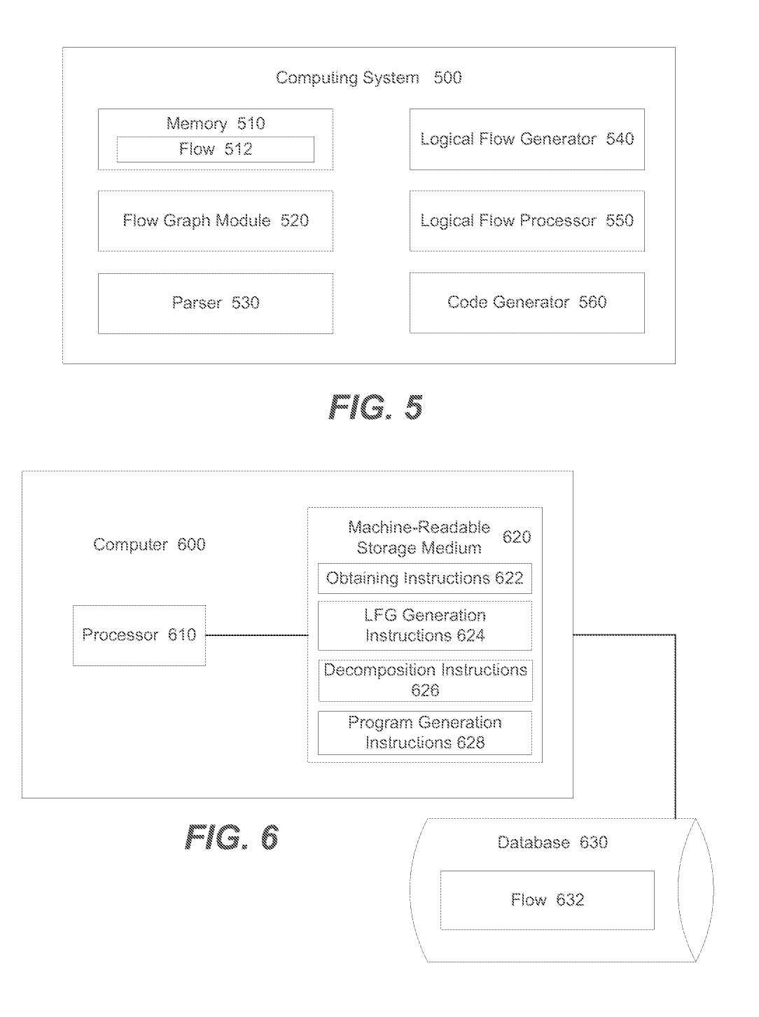

FIG. 5 illustrates a computing system for modifying an analytic flow, according to an example. Computing system 500 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 500 may include one or more machine-readable storage media separate from the one or more controllers.

Computing system 500 may include memory 510, flow graph module 520, parser 530, logical flow generator 540, logical flow processor 550, and code generator 560, and may constitute or be part of an adjunct processing engine. Each of these components may be implemented by a single computer or multiple computers. The components may include software, one or more machine-readable media for storing the software, and one or more processors for executing the software. Software may be a computer program comprising machine-executable instructions.

In addition, users of computing system 500 may interact with computing system 500 through one or more other computers, which may or may not be considered part of computing system 500. As an example, a user may interact with system 500 via a computer application residing on system 500 or on another computer, such as a desktop computer, workstation computer, tablet computer, or the like. The computer application can include a user interface (e.g., touch interface, mouse, keyboard, gesture input device).

Computer system 500 may perform methods 100 and 200, and variations thereof, and components 520-560 may be configured to perform various portions of methods 100 and 200. and variations thereof. Additionally, the functionality implemented by components 520-560 may be part of a larger software platform, system, application, or the like. For example, these components may be part of a data analysis system.

In an example, memory 510 may be configured to store a flow 512 associated with an execution engine. The flow may be expressed in a high-level programming language. Flow graph module 520 may be configured to obtain a flow graph representative of the flow 512. Flow graph module 520 may be configured to obtain the flow graph by requesting an execution plan for the flow 512 from the execution engine. Parser 530 may be configured to parse the flow graph into multiple elements. Logical flow generator 340 may be configured to generate a logical flow graph expressed in a logical language (e.g., xLM) based on the multiple elements. Logical flow processor 550 may be configured combine the logical flow graph with a second logical flow graph to yield a single logical flow graph. Logical flow processor 550 may also be configured to optimize the logical flow graph, decompose the logical flow graph into sub-flows, or present a graphical vie of the logical flow graph. Code generator 560 may be configured to generate a program from the logical flow graph. The program may be expressed in a high-level programming language for execution on one or more execution engines.

FIG. 6 illustrates a computer-readable medium for modifying an analytic flow, according to an example. Computer 600 may be any of a variety of computing devices or systems, such as described with respect to system 500.

Computer 600 may have access to database 630. Database 630 may include one or more computers, and may include one or more controllers and machine-readable storage mediums, as described herein. Computer 600 may be connected to database 630 via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 610 may be at least one central processing unit (CPU), at least one semiconductor-based microprocessor, other hardware devices or processing elements suitable to retrieve and execute instructions stored in machine-readable storage medium 620, or combinations thereof. Processor 610 can include single or multiple cores on a chip, multiple cores across multiple chips, multiple cores across multiple devices, or combinations thereof. Processor 610 may fetch, decode, and execute instructions 622-628 among others, to implement various processing. As an alternative or in addition to retrieving and executing instructions, processor 610 may include at least one integrated circuit (IC), other control logic, other electronic circuits, or combinations thereof that include a number of electronic components for performing the functionality of instructions 622-628. Accordingly, processor 610 may be implemented across multiple processing units and instructions 622-628 may be implemented by different processing units in different areas of computer 600.

Machine-readable storage medium 620 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 620 can be computer-readable and non-transitory. Machine-readable storage medium 620 may be encoded with a series of executable instructions for managing processing elements.

The instructions 622-628 when executed by processor 610 (e.g., via one processing element or multiple processing elements of the processor) can cause processor 610 to perform processes, for example, methods 100 and 200, and variations thereof. Furthermore, computer 600 may be similar to system 500, and may have similar functionality and be used in similar ways, as described above.

For example, obtaining instructions 622 can cause processor 610 to obtain a flow graph representative of flow 632, Flow 632 may be associated with a first execution engine and may be stored in database 630. LEG generation instructions 624 can cause processor 610 to generate a logical flow graph expressed in a logical language (e.g., xLM) from the flow graph. Decomposition instructions 626 can cause processor 610 to decompose the logical flow graph into multiple sub-flows. Program generation instructions 628 can cause processor 610 to generate multiple programs corresponding to the sub-flows for execution on multiple execution engines.

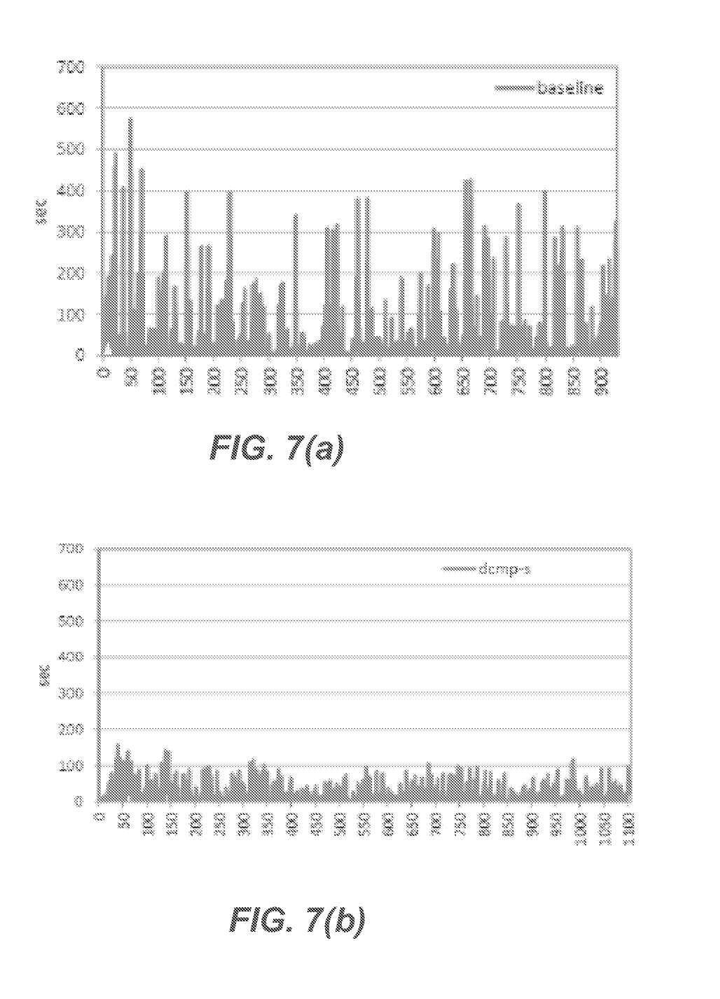

FIGS. 7(a)-(b) illustrate experimental results obtained using the disclosed techniques, according to an example. In particular, the benefit of decomposition of a flow using the techniques disclosed herein is illustrated by these results. The experiment consisted of running a workload consisting of 930 mixed analytic flows. The flows were TPC-DS queries run on a parallel database. Ten instances of a total of 93 TPC-DS queries were run in a random order with MPL 8. The flow instances are plotted on the x-axis while the corresponding execution times are plotted on the y-axis. FIG. 7(a) illustrates shows the workload execution without decomposing any flows. FIG. 7(b) illustrates the beneficial effects of decomposition using the disclosed techniques. In particular, some of the long running flows were decomposed, which created some additional flows resulting in a workload of 1100 flows (instead of 930 flows). Despite the increased workload in sheer number of flows, it is clear that the execution time was significantly improved, especially for the longer running flows from FIG. 7(a). An additional benefit was that the resource contention of the system was improved, as there were no longer any flows monopolizing a resource for a relatively longer period of time than the other flows.

While decomposition can be performed manually or by writing parsers for each engine-specific programming language, the disclosed techniques may avoid this effort by leveraging the ability of execution engines to express their programs as execution plans in terms of datasets and operations (explain plans). It can be much simpler to write parsers for computations expressed in this form, and thus the disclosed techniques enable adjunct processing engines that support techniques (and obtain results) such as that shown in FIGS. 7(a)-7(b).

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method for modifying an analytic flow, comprising, by a processing system:
receiving a flow associated with a first execution engine;
obtaining a flow graph representative of the flow;
modifying the flow graph using a logical language; and
generating a program from the modified flow graph for execution on an execution engine.

2. The method of claim 1, wherein the flow graph is an execution plan output by the first execution engine in response to a request for an execution plan for the flow.

3. The method of claim 1, wherein the flow graph is generated based on a flow specification corresponding to the flow.

4. The method of claim 1, wherein modifying the flow graph comprises:
parsing the flow graph; and
converting the parsed flow graph to a second flow graph in the logical language.

5. The method of claim 4, wherein modifying the flow graph further comprises optimizing the second flow graph.

6. The method of claim 4,
wherein modifying the flow graph further comprises decomposing the second flow graph into sub-flows, and
wherein generating a program from the modified flow graph comprises generating at least a first program based on one of the sub-flows for execution on the first execution engine and a second program based on another of the sub-flows for execution on a second execution engine.

7. The method of claim 4, wherein modifying the flow graph further comprises combining the second flow graph with at least one other flow graph associated with another flow.

8. The method of claim 4, further comprising:
determining a degree of nesting for the flow prior to parsing the flow graph; and
wherein modifying the flow graph further comprises decomposing the second flow graph into sub-flows based on the degree of nesting.

9. The method of claim 8, wherein the degree of nesting is determined based on the flow, an execution window for the flow, the first execution engine, and status information of a system comprising the first execution engine.

10. The method of claim 1, wherein the flow is expressed in a first high-level language associated with the first execution engine and the program is expressed in a second high-level language associated with the execution engine.

11. A system for modifying an analytic flow, comprising:
a flow graph module to obtain a flow graph representative of a flow associated with an execution engine;
a parser to parse the flow graph into multiple elements;
a logical flow generator to generate a logical flow graph expressed in a logical language based on the multiple elements; and
a code generator to generate a program from the logical flow graph.

12. The system of claim 11, further comprising a logical flow processor to at least one of optimize the logical flow graph, decompose the logical flow graph, or present a graphical view of the logical flow graph.

13. The system of claim 12, wherein the logical flow processor is configured to combine the logical flow graph with a second logical flow graph to yield a single logical flow graph.

14. The system of claim 11, wherein the flow graph module is configured to obtain the flow graph by requesting an execution plan for the flow from the execution engine.

15. A non-transitory computer-readable storage medium storing instructions for execution by a computer for modifying an analytic flow, the instructions when executed causing the computer to:
obtain a flow graph representative of a flow associated with a first execution engine;
generate a logical flow graph expressed in a logical language from the flow graph;
decompose the logical flow graph into multiple sub-flows; and
generate multiple programs corresponding to the sub-flows for execution on multiple execution engines.
